(19) United States
(12) Patent Application Publication
(10) Pub. No.: US 2015/0285749 A1
(43) Pub. Date: Oct. 8, 2015

(54) Compact X-Ray Source for CD-SAXS

(71) Applicant: Massachusetts Institute of Technology, Cambridge, MA (US)

(72) Inventors: David Eugene Moncton, Newton, MA (US); William Sproull Graves, Marblehead, MA (US); Franz Xaver Kaertner, Newton, MA (US); Hua Lin, Shanghai (CN); Emilio Alessandro Nanni, Cambridge, MA (US); Luis E. Zapata, Lexington, MA (US); Boris Khaykovich, Brookline, MA (US)

(73) Assignee: MASSACHUSETTS INSTITUTE OF TECHNOLOGY, Cambridge, MA (US)

(21) Appl. No.: 14/678,567

(22) Filed: Apr. 3, 2015

Related U.S. Application Data
(60) Provisional application No. 61/974,583, filed on Apr. 3, 2014.

(51) Int. Cl. G01N 23/201; H05G 2/00

(52) U.S. Cl. CPC G01N 23/201; H05G 2/00

(57) ABSTRACT

The structure of materials can be characterized (e.g., via CD-SAXS) by generating a burst of electron bunches in a pulse train and accelerating the electron bunches to relativistic energies. Meanwhile, an optical cavity is filled with a laser pulse; and the electron bunches collide with the laser pulse in the optical cavity, permitting a single laser pulse to interact with the electron bunch train to generate x-rays via inverse Compton scattering. The generated x-rays are then directed to a sample, and the sample is imaged by measuring the scattering of the x-rays from the sample.

### RELATED APPLICATION

This application claims the benefit of U.S. Provisional Application No. 61/974,583, filed 3 Apr. 2014, the entire content of which is incorporated herein by reference.

### GOVERNMENT SUPPORT

This invention was made with government support under Grant No. N66001-11-1-4192 awarded by the Defense Advanced Research Projects Agency. The Government has certain rights in the invention.

### BACKGROUND

Since their discovery in 1895, x-rays have been the single most powerful technique for determining the structure of all forms of condensed matter. Through increasingly powerful imaging, diffraction, and spectroscopic techniques, physicists, chemists, biologists, and medical doctors, as well as quality-control inspectors, airline passenger screeners, and forensic scientists have resolved the structural detail and elemental constituency on length scales from inter-atomic spacing to the size of the human body. Every day, that knowledge underpins our modern technologies, our health, and our safety. Quite remarkably, for the first 70 of these 114 years, x-ray sources changed little from the original Roentgen tube. Even today, the x-ray technology used in universities, industrial labs and hospitals is derived from this primitive electron tube with minor improvements.

Today, however, the benchmark for x-ray performance is set by large accelerator-based synchrotron radiation facilities, of which more than 60 exist worldwide. Interestingly, despite this large investment in major facilities, 15 of the 19 Nobel Prizes awarded for x-ray-based discoveries used small fixed or rotating-anode-based x-ray sources. The wide availability of modest sources, their ease of use, and their capacity to test new ideas without the barriers of schedule, travel, and expense of the major facilities have led to a remarkable array of scientific breakthroughs.

Inverse Compton scattering (ICS) x-ray sources can exploit head-on inverse Compton scattering (ICS) involving a relativistic electron and a laser photon, where the scattered photon is shifted into the hard x-ray regime. Compton-scattering x-ray sources have shown promising results at low repetition rates. However, all known previous ICS x-ray beams have been of relatively low brilliance, due to poor properties of the electron and optical beam sources.

### SUMMARY

Apparatus and methods for generating x-rays (or other radiation, such as gamma rays) are described herein, where various embodiments of the apparatus and methods may include some or all of the elements, features and steps described below.

In an exemplary method, critical dimension small-angle x-ray scattering (CD-SAXS) is performed by generating a burst of electron bunches in a pulse train and accelerating the electron bunches to relativistic energies. Meanwhile, an optical cavity is filled with a laser pulse; and the electron bunches collide with the laser pulse in the optical cavity, permitting a single laser pulse to interact with the electron bunch train to generate x-rays via inverse Compton scattering. The generated x-rays are then directed to a sample, and feature sizes of the sample are obtained by measuring the scattering of the x-rays from the sample.

In various embodiments, the electron source generates 100 bunches of electrons at 1 kHz; and the apparatus includes a radiofrequency (RF) linear accelerator; a laser system with one oscillator and two amplifier chains (including a first chain of 1 pulse at 1 KHz IR for ICS interaction and a second chain of 100 pulses at 1 kHz UV for a photo cathode in the electron source); a laser cavity for recycling the laser pulse from the first chain; and an integrated x-ray optic for collecting a large spectral bandwidth and angular divergence of the x-rays produced.

The electron source can be an RF photo injector and can operate in the “blowout” regime for producing low-emittance (high-quality) electron bunches. Low emittance is advantageous for high x-ray output and proper interaction with the laser pulse. The electron source can also have high gradients (>100 MV/m) on the electron emission surface for producing low-emittance (high-quality) electron bunches. Special thermal considerations for achieving a 1 kHz repetition rate include a short cavity fill time, targeted placement of cooling channels, dynamic control of coolant temperature, and deformation of cavity irises.

The RF linear accelerator can operate in a standing wave mode for efficiency, and the same RF driver can be used for the electron source and accelerator for synchronization and cost savings.

The electron bunch can be focused after acceleration to a small spot (e.g., with a diameter of about 1 micron). This focal point is the interaction point between the electron bunch and the colliding laser; and this size is close to the diffraction limit of the laser spot. The electron bunch length can be ˜1 picoseconds (ps).

The amplifier chains for the laser can be synchronized within much less than 0.1 ps because they are driven by the same oscillator. The oscillator can be at a sub-harmonic or harmonic of the laser cavity repetition rate. The second amplifier chain can produce a ˜100 femtosecond (fs) ultraviolet pulse for operating in the “blowout” regime. The first amplifier chain can produce a 2-4 ps IR pulse. This pulse length matches well with the electron bunch length, and the pulse length matches the laser Rayleigh range at the interaction point.

The output of the first amplifier chain can be coupled into a linear cavity through a dichroic mirror, and the IR pulse can be converted to green through second harmonic generation. The cavity produces a small focal spot (several microns) that approaches the diffraction limit, which maximizes the x-ray output. This focal spot overlaps with the electron spot.

The laser cavity can be designed to operate in a 4f configuration. The laser cavity may be asymmetric; i.e., the focal length of the lens and mirror may be unequal. The configuration minimizes the accumulated B-integral—B-integral leads to degradation of the laser pulse in the cavity and damage. Surface fields can be below the damage threshold of the optical components, and the laser cavity loss can be less than 1%. This allows for 100 or more interactions in the cavity between the laser pulse and the electron bunches, as each electron bunch interacts with the laser pulse from a different round trip in the cavity.

The laser cavity can be at a small angle (e.g., about 5 degrees) with respect to the electron beam, which avoids radiation damage, and avoids loss of x-ray output flux.

The x-ray beam can be collected by a Montel (or nested Kirkpatrick-Baez) optic that focuses or collimates the beam. This optic can collect a large angle of the x-rays produced (e.g., 10 mrad) and 5% of the bandwidth of x-rays produced.

The interaction region design can include the laser cavity tilted at a small angle with respect to the electron beam, a bending dipole to divert the electron beam from the x-ray beam, quadrupole focusing within centimeters of the interaction point, laser focusing within centimeters of the interaction point, and an x-ray optic placed within centimeters of the interaction point due to the tilted cavity and due to the bending of the electron beam. This proximity decreases the cost of the optic and increases its performance and allows for a diverging x-ray source.

This source can be optimized for CD-SAXS at, e.g., 17 keV for metrology of semiconductor (e.g., Si or GaAs) chips. X-ray beams produced by this source have the same broad suite of applications as large synchrotron or free electron laser facilities, including lithography, protein crystallography, ultrafast chemistry, and x-ray imaging. Due to its small size and high performance, this source has applications in hospitals, industrial labs, and universities. For example, the source can be configured as a powerful source of soft x-rays for use in electronic chip manufacturing.

The compact x-ray sources described herein can enable x-ray beam performance that approaches the performance of the mega-facilities in general; and, in critical parameters, such as pulse length and source size, the compact x-ray sources may surpass them, which may facilitate major advances, for example, in ultrafast x-ray science and diagnostic phase-contrast imaging. For ultra-fast x-ray diffraction, to understand matter far from equilibrium or to study chemical reactions in real time, compact x-ray light source technology can produce powerful pulses of x-rays having time duration well under a picosecond. New phase-contrast imaging methods, already demonstrated on large synchrotrons, may accordingly be made available in hospitals to provide a new tool in the battle against breast cancer or heart disease.

A compact hard x-ray source with properties appropriate for a critical dimension small-angle x-ray scattering (CD-SAXS) tool can be advantageously used to characterize nanometer-scale features on semiconductor structures. The inverse Compton scattering (ICS) of short electron bunches on a high-power laser can produce an x-ray flux orders of magnitude higher than existing compact sources and can produce SAXS data at a rate comparable with a major synchrotron.

The future requirements for accurate and precise measurement of the critical dimensions (CD) of advanced 3D microelectronic architecture will not be satisfied by optical methods as the technology moves below the 22 nm node. For 3D structures, such as FinFETs and high-aspect ratio (HAR) memory devices, the key process parameters, such as feature heights, sidewall angles, and oxide and nitride layer thicknesses, are readily accessible by small-angle x-ray scattering (SAXS) methods as demonstrated in synchrotron-based studies. These studies also clearly imply that CD-SAXS will require a high-brilliance and compact x-ray technology if this diagnostic method is to be integrated into industrial fabrication lines.

Existing methods of CD-SAXS studies include characteristic x-rays from an x-ray tube using a liquid metal jet anode and large synchrotrons. X-ray tube sources, even with the enhanced performance offered by liquid metal anodes, provide 2-3 orders of magnitude less flux than the source described herein; and the radiation wavelength from x-ray tube sources is not optimal since it is fixed to certain atomic transition lines available from the liquid metal. Synchrotron facilities have higher demonstrated x-ray performance than the source described herein but cost $100 million to $1 billion and have kilometer lengths. The estimated cost of the source described herein is less than $5 million, and its size is less than 5 meters, features which make it commercially viable and suitable for installation in existing Si wafer-fabrication plants.

In addition to entirely new applications, these compact sources offer many other advantages. For example, these compact sources, may accelerate the pace of drug discovery by providing protein structure solutions immediately upon crystallization, rather than waiting precious days, weeks, or sometimes months for access to the big, remote synchrotrons. For the first time, educational institutions may have the ability to train students in these powerful emergent applications of x-rays without the often prohibitive constraints of travel and the limitations of beam time. Electronic chip manufacturing facilities can use these sources to perform in-situ metrology of today's three-dimensional nanometer sized structures. Museums and other cultural institutions can perform in-house x-ray analysis on historic works of art. Advanced major facilities, such as the National High Magnetic Field Laboratory and Spallation Neutron Source at Oak Ridge National Laboratory, can benefit from a compact source to combine x-ray analysis with magnetic and neutron studies. Finally, the characteristics of the x-rays produced by such compact sources can be improved through research and development, increasing flux and coherence with the ultimate goal of achieving a compact x-ray source with fully coherent hard x-ray beams.

These compact sources may also open up new scientific frontiers, particularly in ultrafast dynamics and spectroscopy. Although these capabilities may not match the standard expected for fourth-generation light sources, these compact sources can provide x-ray parameters approaching those of current third-generation light sources for a fraction of the cost; and, in some parameters, such as pulse length and source size, may significantly exceed what is possible at the major facilities. In addition to the economic benefits, the flexibility of these sources can provide high brilliance x-rays in environments where they are not currently possible.

### BRIEF DESCRIPTION OF THE DRAWINGS

FIG. 1 schematically illustrates an embodiment of the accelerator, laser, and x-ray components of an ICS x-ray source.

FIGS. 2 and 3 are plots of total x-ray output near 12 keV, where the flux at 100 kHz is 2×10¹² photons/second into all angles and energies. FIG. 2 shows flux versus angle, and FIG. 3 shows color-coded intensity versus angle and photon energy. The off-axis photons are lower energy and wider bandwidth than on-axis emission.

FIGS. 4 and 5 are plots of x-ray intensity versus opening angle for 5% bandwidth (FIG. 4) and 0.1% bandwidth (FIG. 5) at 12 keV. Flux is contained within a half angle of 5 mrad.

FIGS. 6 and 7 are plots of brilliance (FIG. 6) and flux (FIG. 7) versus collection angle for 5% bandwidth and 0.1% bandwidth at 12 keV.

FIG. 8 illustrates an intricate arrangement of the laser, electron, and x-ray components near the interaction point. Each of the three beams is directed through a strong lens near the interaction point that does not interfere with the other beams.

FIGS. 9 and 10 are plots of flux (FIG. 9) and brilliance (FIG. 10) as a function of laser focus size (w₀). Each curve represents a different laser full width at half maximum (FWHM) pulse length from 0.5 to 4 ps. The large circle in each plot marks the operating point for the design laser, which takes into account laser gain and bandwidth, average power, and peak power.

FIG. 11 is a plot of the simulated time duration of the x-ray pulse at 12 keV. The time duration is nearly equal to the electron bunch length and does not depend on the laser pulse length. The plot shown is without compression—electron bunch compression would produce significantly shorter pulses.

FIG. 12 is a partially sectioned computer-aided design (CAD) layout of components for a compact x-ray source, including an RF gun, a short linear accelerator (LINAC) and transport magnets, high-power lasers, and an interaction area. Shielding, not shown, can be fitted directly to the accelerator.

FIG. 13-16 are plots of longitudinal beam parameters at the RF gun exit versus time relative to bunch center. FIG. 13 shows time-energy phase space with mean energy of 2.9 MeV and rms bunch length of 260 fs (1° RF). FIG. 14 shows an ellipsoidal distribution resulting from blowout-mode dynamics. FIG. 15 shows electric current as a function of time, with 120 A peak current. Meanwhile, FIG. 16 shows an energy spread that is higher in the head tail; however, energy spread remains below 1.5 keV for all time slices. Bunch length is a factor of 4 longer than in a cathode laser.

FIGS. 17-20 are plots of horizontal and vertical transverse beam parameters at the gun exit versus time relative to bunch center. FIGS. 17 and 18 show alpha and beta Twiss parameters for each time slice. The plot of FIG. 19 shows a mismatch factor, B_{mag}; and the plot of FIG. 20 shows slice emittance.

FIGS. 21-24 are plots of longitudinal beam parameters at the interaction point versus time relative to bunch center. FIG. 21 shows time-energy phase space with a mean energy of 17.9 MeV and rms bunch length of 580 fs, a factor of two longer than at gun exit due to space charge dynamics. FIG. 22 shows that the entire beam focuses well to a 3-micron spot. FIG. 23 shows 60 A peak current; and FIG. 24 shows that slice energy spread has increased due to space charge forces at small focus. However, slice energy spread remains below spread due to RF curvature.

FIGS. 25-28 are plots of horizontal and vertical transverse beam parameters at the interaction point versus time relative to bunch center. FIGS. 25 and 26 show alpha and beta Twiss parameters for each time slice. The plot of FIG. 27 shows mismatch factor, B_{mag}; and the plot of FIG. 28 shows slice emittance. B_{mag} is a measure of the overlap of each phase space time slice with the central slice and ideally is equal to one for all time slices.

FIG. 29 is a schematic diagram of a laser system, showing a Yb:KYW photocathode laser that produces a 100 pulse train at a 1 kHz repetition rate and a Yb:YAG amplifier chain that produces a single 100 mJ infrared pulse that is converted to 50 mJ of green light via second harmonic generation at 1 kHz that rings down in a cavity and collides with the electron bunch train.

FIG. 30 shows components in a high-average-power, high-pulse-energy chirped pulse amplifier design, including a shaped, composite, thin-disk gain element (insert) that is cryogenically cooled and a passively switched strictly image-relayed multipass architecture utilizing a beam-smoothing telescope.

FIG. 31 is a schematic illustration of an embodiment of the linear cavity.

FIG. 32 is a plot of pulse energy and B-integral as a function of pass number in the ringdown cavity.

FIG. 33 is a cutaway view of a 3.5 cell RF photoinjector. The “half” cell is substantially shortened to allow laser timing near the peak of the RF field.

FIG. 34 schematically shows a layout of CD-SAXS optics.

In the accompanying drawings, like reference characters refer to the same or similar parts throughout the different views; and apostrophes are used to differentiate multiple instances of the same or similar items sharing the same reference numeral. The drawings are not necessarily to scale; instead, emphasis is placed upon illustrating particular principles in the exemplifications discussed below.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially, though not perfectly pure, as practical and imperfect realities may apply; e.g., the potential presence of at least trace impurities (e.g., at less than 1 or 2%) can be understood as being within the scope of the description; likewise, if a particular shape is referenced, the shape is intended to include imperfect variations from ideal shapes, e.g., due to manufacturing tolerances. Percentages or concentrations expressed herein can represent either by weight or by volume. Processes, procedures and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

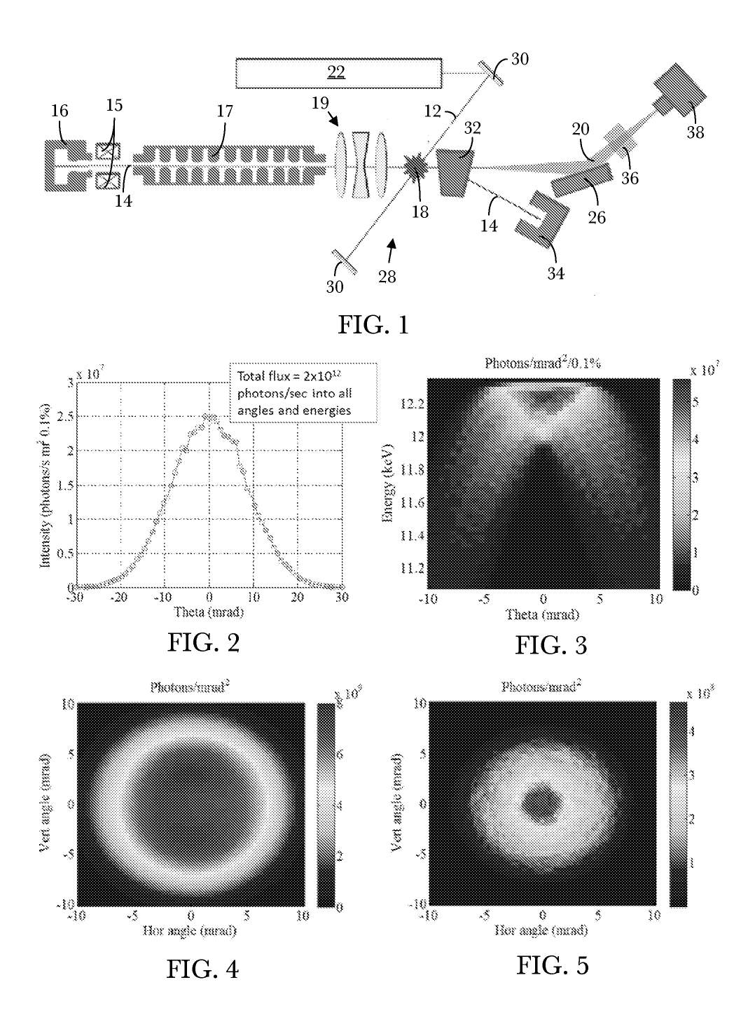

Inverse Compton scattering is the up-conversion of a low-energy laser photon to a high-energy x-ray by scattering from a relativistic electron (e.g., when the electron energy exceeds its rest energy (0.511 MeV); the velocity of the electron is then 87% of the speed of light). FIG. 1 shows the geometry of the interaction with a near head-on collision between the laser beam 12 and electron beam 14, where the total length from the cathode of the radiofrequency (RF) gun 16 through the solenoid magnets 15, through a one-meter-long linear accelerator 17, and through quadrupole magnets 19 to the inverse Compton scattering (ICS) interaction point 18 is 2.5 meters. The length of the x-ray beamline depends on the experiment but is typically 1 meter. Relatively large x-ray divergence of several mrad leads to shorter beamlines. The scattered x-rays 20 emerge from the ICS interaction point 18 in the same direction as the electrons 14. The physics of ICS are nearly identical to spontaneous synchrotron emission in a static magnetic undulator, as used at the large traditional synchrotron facilities; but, because the wavelength of the laser is much shorter than a static undulator period, the energy required of the electrons 14 to make hard x-rays 20 is orders of magnitude lower than it is in the large synchrotrons, reducing the size and cost of the compact ICS source by orders of magnitude.

The resulting x-rays can then be passed through a sample 36 and captured at a detector 38 to generate an x-ray image of the sample 36.

### X-Ray Source Optimization:

For a scattering process, such as ICS, the highest flux is produced by creating the densest target in order to increase the probability of scattering. High density is achieved by squeezing the electron and laser beams 14 and 12 in each of their dimensions. Thus, the laser pulse 12 is short in time and is focused to a small waist. Likewise, the electron beam 14 is focused to a small spot and is of short duration to interact efficiently with the laser beam 12. The x-ray source is optimized to produce a small, radially symmetric x-ray beam 20 of a few (e.g., 2-5) microns diameter and having an opening angle of a few (e.g., 2-5) mrad. This source contrasts with a typical synchrotron beam that has a source size of 100 μm and an opening angle of perhaps 100 grad. However, because the product of source size and divergence for the ICS and synchrotron sources are similar, x-ray optics 26 can be used to collimate the ICS x-ray beam 20, producing a larger virtual source with a smaller opening angle similar to synchrotron radiation.

There are, of course, limits to improvements in x-ray output by focusing to ever smaller spots. For the electron beam 14, the emittance is the determining factor. The emittance (a conserved quantity) of an electron beam 14 at a focus is just the product of the beam size and its divergence. Making a smaller focus means that the divergence is larger; and, eventually, the spread in angles of the electron trajectories will become the dominant cause of increase for both the bandwidth and the opening angle of x-rays 20, lowering the beam brilliance. The laser beam focus size is advantageously similar to the electron beam size to maximize the interaction, but this matching sets limits on acceptable pulse lengths.

The optimum pulse lengths for both the electron beam 14 and laser beam 12 depend also on the focus size. Neglecting nonlinear effects that are weak at the milliJoule laser energy of the present study, x-ray production scales as the square of the laser intensity so it is important for the electron/laser interaction at point 18 to take place within the Rayleigh diffraction length of the laser beam 12. The Rayleigh length, Z_{R}=πw₀²/λ_{L}, depends strongly on the laser waist size, w₀. Z_{R} can become much shorter than the laser pulse length for small w₀, reducing the x-ray flux. The shortest laser pulse length is generally determined by the laser bandwidth, which depends on the particular laser material chosen. The laser 22 needs to be able to produce short pulses 12 with high pulse energy and high average power, limiting the selection of materials to a few candidates. The electron bunch 14 is also constrained to interact within Z_{R}, so it must be short as well. Note that the output x-ray pulse length depends only on the electron bunch length and not the laser length in the same way that the undulator x-ray pulse length does not depend on undulator length. The quantitative effects of pulse length and focus size are shown in numerical studies, below. First, relations are derived that guide the design of the electron and laser beams and the resulting x-ray source.

The resonant wavelength for the ICS fundamental wavelength is expressed as follows:

$${λ}_{x} = \frac{{λ}_{L}}{2 {γ}^{2} ( 1 - {β}_{z} cos ϕ )} ( 1 + {a}_{0}^{2} / 2 + {γ}^{2} {θ}^{2} ) , \qquad ( 1 )$$

where λ_{L} is the laser wavelength, γ is the electron energy in units of rest mass, φ is the electron-laser collision angle (φ=π for head-on), and

$${a}_{0} = \frac{{eEλ}_{L}}{2 π {mc}^{2}}$$

is the dimensionless vector potential of the laser field. The angle between the electron direction of motion and an observer is θ. For low laser intensity and on-axis emission from a head-on collision with a relativistic beam, the resonant wavelength is

$${λ}_{x 0} = \frac{{λ}_{L}}{4 {γ}^{2}} .$$

For high laser intensity with multi-Joule pulses, a₀≧1, harmonic power and distortion of the fundamental linewidth become important. However, in the present case, where high repetition rate is important, the peak intensity is modest, a₀≦0.3, and a weakly nonlinear approximation is used to accurately model the on-axis spectrum.

The x-ray bandwidth (FIGS. 2 and 3) is determined by several factors, including the laser bandwidth, which represents the minimum possible x-ray bandwidth, the electron beam energy spread and emittance, and the wavelength shift represented by the a₀ factor in Eq. 1 that depends on the time-varying laser intensity. The central wavelength of the output x-rays 20 is rapidly tunable by varying the electron energy. The minimum x-ray bandwidth is the inverse of the number of laser periods 1/N_{L}, which is similar to the relationship between undulator radiation bandwidth and the number of undulator periods. As an example, a 1 ps laser at 515 nm wavelength has 580 periods, and so the minimum bandwidth is about 0.2%. This value may be broadened by several effects. From Equation 1, the contribution of electron energy spread to broadening is as follows:

$${( \frac{{Δλ}_{x}}{{λ}_{x}} )}_{{Δ}_{y}} = 2 \frac{Δγ}{γ} . \qquad ( 2 )$$

From numerical simulation, the expected electron energy spread is 0.1%, in which case, the broadening is similar to the fundamental line width. Another effect is the intensity-dependent term, a₀²/2, in Equation 1, which results in a red shift of the emission due to a slowing down of the average electron velocity in strong laser fields. A conservative estimate of the bandwidth due to this effect is as follows:

$${( \frac{{Δλ}_{x}}{{λ}_{x}} )}_{{a}_{0}} = \frac{{a}_{0}^{2}}{2} . \qquad ( 3 )$$

For the present case, a₀=0.1 at the focus so that the relative broadening is at the 1% level. This estimate is conservative because the probability of emission also scales as a₀² so that most of the emission occurs near the maximum value of a₀. The electron emittance affects the bandwidth through the variation in electron-laser collision angle, φ, and the change in apparent observation angle, θ. At a focus, the normalized electron emittance is Eₓₙ=γσₓσₓ, where σₓ is the root-mean-square (rms) beam size, and σ_{x′} is the rms spread in electron angles relative to the axis. Equating σ_{x′} to the effective observation angle, θ, in Equation 1 results in the following broadening of the equation:

$${( \frac{{Δλ}_{x}}{{λ}_{x}} )}_{{ɛ}_{xn}} = {γ}^{2} {θ}^{2} = \frac{{ɛ}_{xn}^{2}}{{σ}_{x}^{2}} . \qquad ( 4 )$$

As with the other contributions, we wish to limit this effect to <1% so that the electron focus size, σₓ≧10∈ₓₙ. In the present case, the emittance is 0.3×10⁻⁶ m-rad, so the electron focus size should be σₓ≧2 μm.

Turning to numerical simulations, several codes are run to create detailed time-dependent models of the electron beam 14 and laser beam 12 and the x-ray beams 20 they produce. The electron beam 14 is modeled starting from the photoemission at the cathode of the RF gun 16 through acceleration and transport to the ICS interaction point (IP) 18 with the code, PARMELA, a time-dependent particle-in-cell (PIC) code including space charge effects. A suite of codes is used to model the laser amplifier 22 and the ringdown cavity 28 between mirrors 30. The electron and laser simulations are described in more detail in the technical sections that follow. The resulting laser and electron pulses 12 and 14 are then input into the code, COMPTON, which performs time-dependent 3D simulations of the incoherent ICS process, including weakly nonlinear effects.

FIGS. 2 and 3 show output from COMPTON, with plots of total flux versus angle and a color plot of x-ray intensity versus angle and photon energy. Inspecting the plot of FIG. 3, the vertical width of the intensity band represents energy bandwidth. It is apparent that the on-axis bandwidth is quite narrow (0.7% in this case due to all of the effects described above); but, as radiation is collected at larger angles, the bandwidth is substantially broadened and emitted at lower photon energy. These off-axis effects are due to the γ²θ² term in Equation 1 creating an energy-angle correlation. The same phenomenon occurs, of course, with undulator radiation; however, the low electron energy used in ICS (one of its primary advantages) results in a larger opening angle of the radiation. Note that even though the plot is not as intense at larger angles, the integrated flux at those angles is substantial and useful for experiments that can tolerate the wider bandwidth. The radiation contained within the central bandwidth is emitted into a fairly narrow cone of half angle 5 mrad.

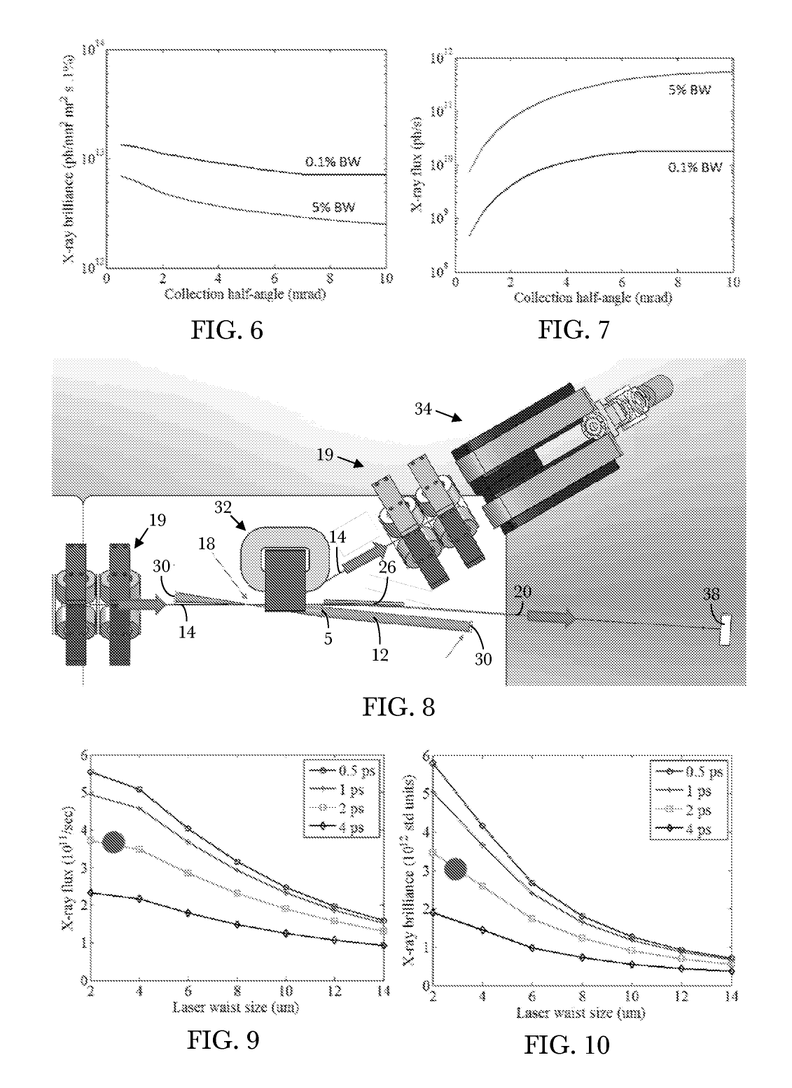

FIGS. 4 and 5 shows x-ray intensity versus horizontal and vertical angles for bandwidths of 5% and 0.1%. The acceptable bandwidth depends on the application, with, e.g., Laue scattering and critical-dimension small-angle x-ray scattering (CD-SAXS) techniques able to use a broad bandwidth, while protein crystallography requires narrow bandwidth. For the set of parameters under study, the average flux into 5% bandwidth is 5×10¹¹ photons/sec, while for a narrow 0.1% window, the average flux is 3×10¹⁰ photons/sec. FIGS. 6 and 7 show how the brilliance and flux scale with collection angle for narrow and wide bandwidth.

Assuming Gaussian laser and electron beam profiles, an analytic expression for the total x-ray dose produced by a head-on inverse Compton scattering interaction is as follows:

$${N}_{x} = \frac{{N}_{e} {N}_{L} {σ}_{T}}{2 π ( {σ}_{L}^{2} + {σ}_{x}^{2} )} FF . \qquad ( 5 )$$

In Equation 5, σ_{T} is the total Thomson cross section, Nₑ is the total number of electrons, and N_{L} is the total number of photons in the laser beam. The term, FF, is a form factor less than unity that depends on rms pulse durations, Δt_{L} and Δtₑ, and beam spot sizes, σ_{L} and σₓ, at the interaction point 18 for the laser and electron beams 12 and 14. FF represents the degradation of the interaction efficiency for cases where the pulse durations exceed the interaction diffraction lengths of the laser and electron beams 12 and 14. The resulting x-ray brilliance is expressed as follows:

$${B}_{x} \approx 1.5 \times {10}^{- 3} \frac{{N}_{e} {N}_{L} {σ}_{T} {γ}^{2}}{{( 2 π )}^{3} {ɛ}_{xn}^{2} {σ}_{L}^{2}} {F}_{rep} . \qquad ( 6 )$$

In order for Equation 6 to be valid, both the electron and laser pulse durations should not significantly exceed the laser Rayleigh length, Z_{R}. Additionally, σ_{L} should not be so small that the nonlinear effects begin to degrade the scattered x-ray spectrum. For λ_{L}=515 nm and a₀ₘₐₓ≈0.1, pulse durations on the order of a pico-second and interaction spot sizes of a few microns are advantageous to achieve optimum x-ray beam brightness.

An intricate arrangement of the laser beam 12, electron beam 14, and x-ray components near the interaction point is shown in FIG. 8. Each of the three beams is directed through a strong lens near the interaction point 18 that does not interfere with the other beams.

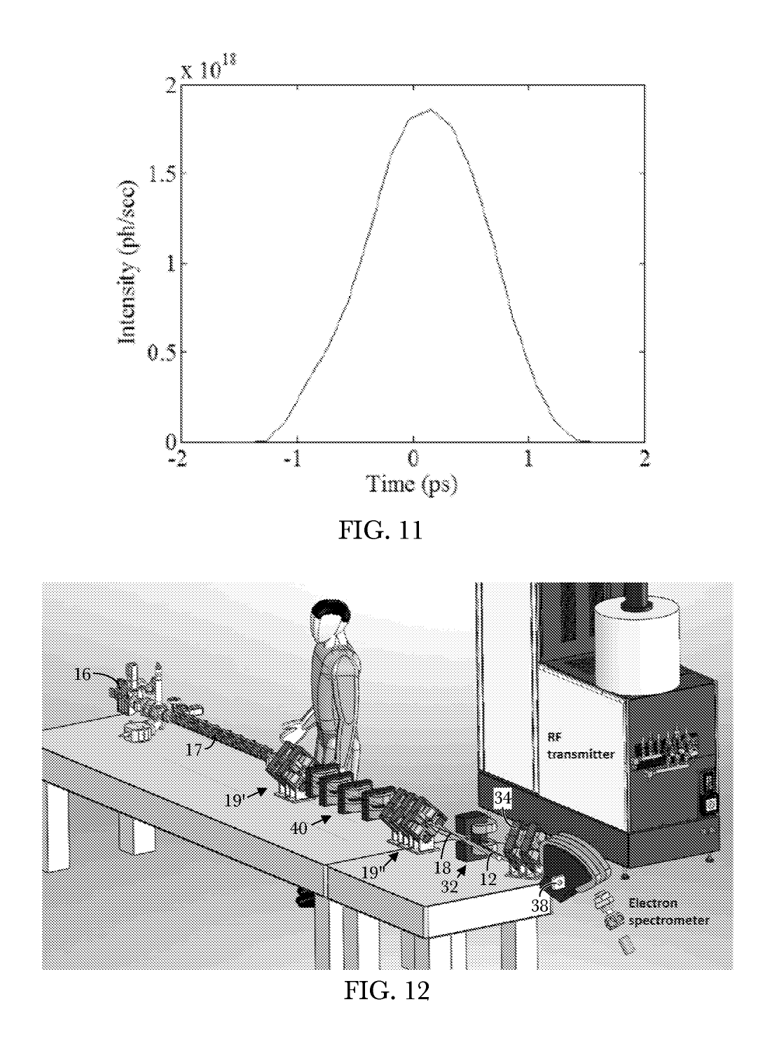

FIGS. 9 and 10 show numerical results of the effects of laser pulse length and focus size on brilliance and flux. Ideally, a pulse length less than 1 picosecond (ps) with a near diffraction-limited focus size will produce the highest output. Practical considerations for laser materials led us to choose a cryo-cooled Yb:YAG laser, which is capable of 2 ps pulse duration with very high average and peak power. The intended operating points are marked on the plots. A cryo-cooled Yb:YLF laser may provide sub-ps pulses at high average power. The x-ray pulse time profile is shown in FIG. 11 with an rms pulse length of 490 fs, similar to that of the electron beam 14. Because the electrons 14 are propagating at close to the speed of light, the x-ray pulse length depends only on the electron bunch length and, for practical purposes, is independent of the laser pulse length.

In summary, the optimization of high average flux, high spectral brightness inverse Compton scattering x-ray sources utilizes electron beams 14 with low emittance (<500 nm-mrad) and short pulse duration (<1 ps), and tightly focused (<5 μm), short pulse (<1 ps) lasers 22. The technical aspects of the laser and electron beams 12 and 14 and the equipment used to produce them are presented in the sections that follow. The x-ray performance resulting from numerical optimization of the ICS source using state-of-the-art laser and accelerator technology is presented in Table I, below.

TABLE I
Estimated performance at 0.1% and 5% bandwidth
for 12.4 keV x-rays from the compact source:

| | 0.1% | 5% | |
|---|---|---|---|
| Parameter | bandwidth | bandwidth | Units |
| Photon energy | 12.4 | 12.4 | keV |
| Average flux | 2 × 10¹⁰ | 5 × 10¹¹ | phot/s |
| Average brilliance | 7 × 10¹² | 2 × 10¹² | photons/ |
| | | | (secmm²mrad²0.1%) |
| Peak brilliance | 3 × 10¹⁹ | 9 × 10¹⁸ | photons/ |
| | | | (secmm²mrad²0.1%) |
| RMS hor. opening angle | 3.3 | 4.3 | mrad |
| RMS ver. opening angle | 3.3 | 4.3 | mrad |
| RMS hor. source size | 2.4 | 2.5 | μm |
| RMS ver. source size | 1.8 | 1.9 | μm |
| RMS pulse length | 490 | 490 | fs |
| Photons/pulse | 2 × 10⁵ | 5 × 10⁶ | — |
| Repetition rate | 100 | 100 | kHz |

### Electron Beam Dynamics:

The electron bunch charge may be set as large as possible to maximize x-ray flux, but is constrained by the needs for small emittance and bunch length in order to produce bright x-rays 20, as well as by the effects of beam loading and wakefields on the RF structures. The maximum bunch charge is also limited by the available cathode-laser power and the cathode quantum efficiency (QE). The emittance requirement, ∈ₓₙ−0.2 μm, is set so that the electron divergence at the micron-sized focus at the interaction point 18 is less than the radiation opening angle of 1/γ. The bunch length during acceleration is advantageously limited to a few RF degrees (3°=1 ps) so that the energy spread remains small. The blowout mode of generating an ellipsoidal bunch distribution is used for its ability to generate short bunches with a uniform charge distribution that exhibits linear space charge forces (thus avoiding emittance growth). These bunches are well suited for temporal compression and show excellent focusing characteristics for producing micron-sized spots at the interaction point 18. The blowout method reduces sensitivity to laser temporal pulse shaping and inhomogeneities in the cathode emission. Furthermore, because the transverse space charge forces are not only linear, but also identical in each time slice, there is little relative rotation of the time slices in phase space so that emittance compensation schemes are less critical.

TABLE II
Cathode and Initial Electron Beam Parameters:

| Parameter | Value | Unit |
|---|---|---|
| Normalized emittance | 1 × 10⁻⁷ | m-rad |
| Peak current | 120 | Amps |
| Bunch charge | 100 | pC |
| Laser FWHM length | 150 | fs |
| Laser temporal shape | Arbitrary | |
| Laser spatial shape | Parabolic | |
| Laser edge radius | 0.6 | mm |
| Peak RF field | 140 | MV/m |
| RF phase at emission | 50 | degrees |

For robustness in the high 140 MV/m RF fields, a copper cathode with a design quantum efficiency (QE) of 5×10⁻⁵ at the 140 MV/m applied RF field was chosen. The available cathode laser power of 20 W is consistent with producing bursts of 100 bunches in 0.5 microseconds (μs) at a repetition rate of 1 kHz. The bunch charge is also limited by beam loading of the RF fields. The 10 nC contained in the bunch train produces a linear accelerator (LINAC) beam loading of 16%.

The initial electron beam emittance is ∈ₓₙ=σₓ\sqrt{(hν−φ)/3mc²}, where hν=4.81 eV is the photon energy of the frequency-quadrupled Yb:KYW laser 22, φ=4:59 eV is the work function of Cu(100), and σₓ is the root-mean-square (rms) beam size. Leaving margin for downstream emittance growth, an initial emittance target of 0.1 μm was chosen, resulting in a laser spot rms radius of 260 μm, or an edge radius of 600 μm for the parabolic intensity profile. The initial rms pulse length is 75 fs, set by the ultraviolet (UV) laser 22.

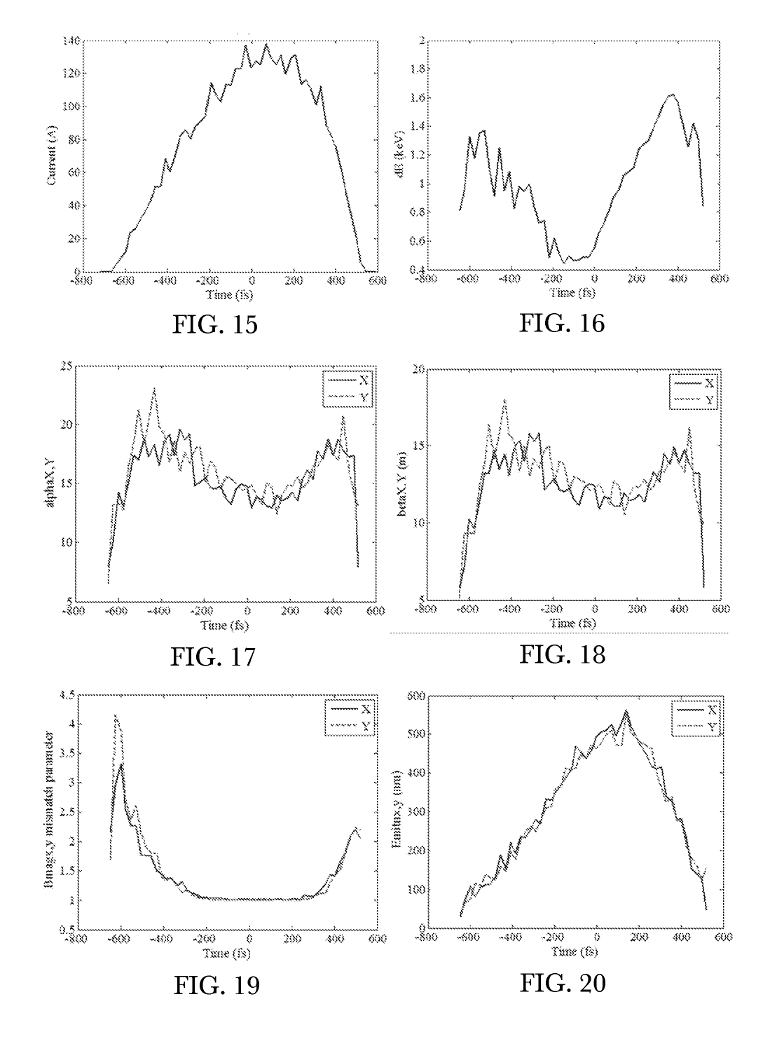

To properly set up the dynamics of the blowout mode, the space charge field near the cathode must be much smaller than the applied radiofrequency (RF) field but large enough that the bunch length at the exit of the RF gun 16 is significantly longer than its initial value. In the thin-disk approximation, the peak space charge field is 3/2Q/(∈₀πr²)=16 MV/m. The RF field at the time of emission is 140 sin(50)=108 MV/m, satisfying the first condition. Numerical simulations (plotted in FIGS. 13-16) indicate that the second condition is satisfied as the rms bunch length increases from 75 fs to 260 fs at the gun exit, resulting in a peak current of 120 A. FIGS. 13-16 also show that the bunch has expanded into the desired ellipsoidal distribution at an energy of 2.9 MeV. The longitudinal phase space shown in FIG. 13 indicates that the blowout mode has created a chirped energy distribution (for the expansion). The plot of FIG. 16 shows that the slice energy spread varies from 0.5 keV at the beam center to 1.6 keV at the head and tail, consistent with blowout-mode dynamics, where it is the variation in velocity that creates the ellipsoidal distribution. Although the peak current at the gun exit is quite high, due to the low energy of the entire machine, the bunch will continue to stretch up until the laser interaction, resulting in a lower peak current at the interaction point.

Plots of the horizontal and vertical transverse beam parameters at the gun exit versus time relative to bunch center are provided in FIGS. 17-20. Alpha and beta Twiss parameters for each time slice are plotted in FIGS. 17 and 18. The plot of FIG. 19 shows a mismatch factor, B_{mag}; and slice emittance is shown in the plot of FIG. 20.

Electrons produced at the flat copper cathode can be accelerated to 3 MeV in the 3.5 cell gun 16. The electron beam 14 exiting the gun 16 is focused by a 6-cm-long solenoid with a peak field of 5 kG to a soft waist of 480 μm at the entrance to the linear accelerator (LINAC) 17 to match the Ferrario criterion for generating an electron bunch 14 with time slices that are well aligned in phase space, resulting in a low overall projected emittance at the exit of the LINAC 17. The short one-meter-long standing wave LINAC 17 then accelerates the electron bunch 14 to the energy required for x-ray production, 17.8 MeV in the case of 12.4 keV x-rays. The gun 16 and the LINAC 17 are high-efficiency 9.3-GHz x-band devices powered by a 6 MW RF transmitter operating at up to 1 kHz.

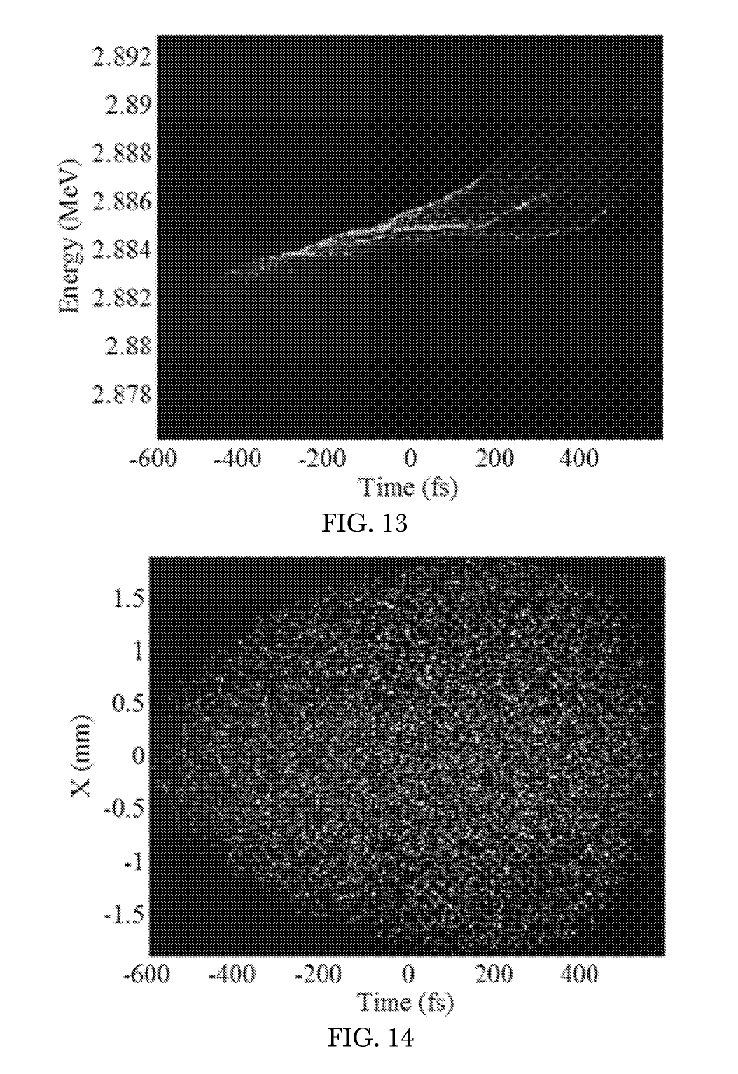

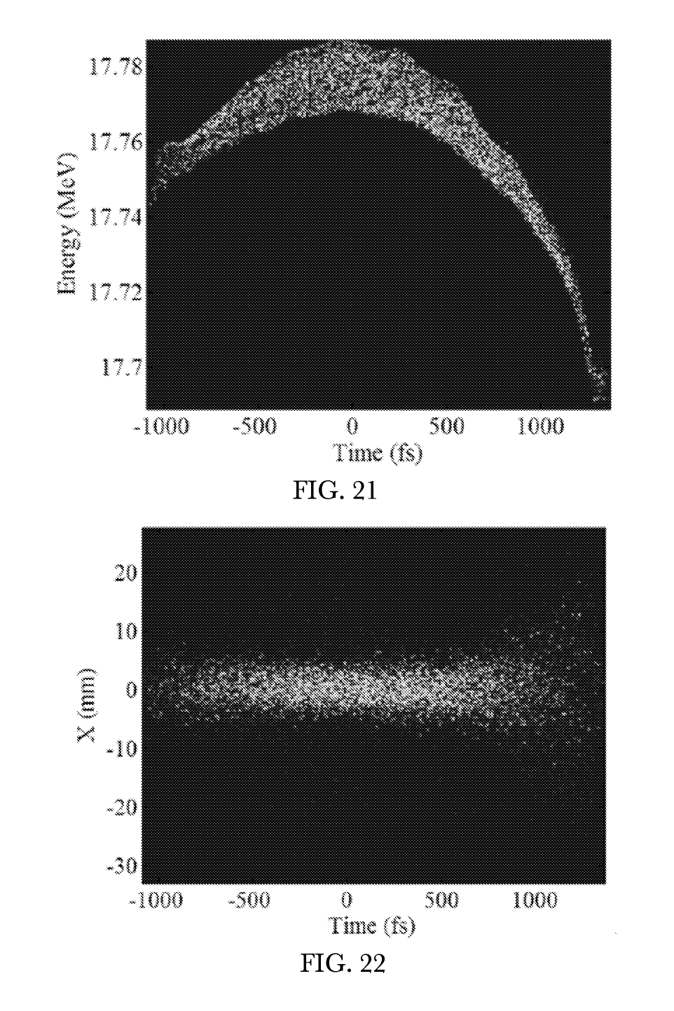

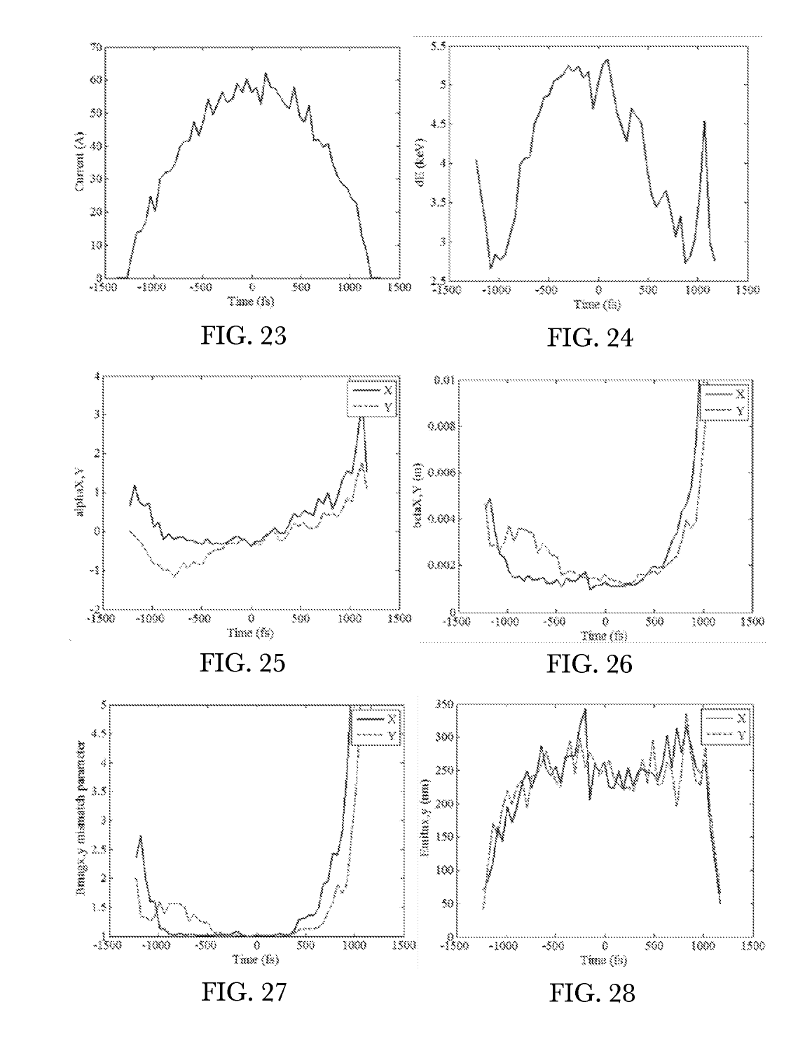

As shown in FIG. 12, downstream of the LINAC 17 is a quadrupole magnet pair 19′ to match into a four-magnet chicane 40 that is used primarily to block unwanted stray electrons from entering the laser interaction area using energy and spatial filtering. The quadrupole magnets 19′ focus the electron beam 14 to a ˜3 μm spot at the interaction point 18, where it collides with the green inverse-Compton-scattering laser beam 12. The chicane 40 can also be used for bunch compression to produce electron bunches 14 less than 100 fs in duration. Following the chicane 40, a short focal length quadrupole triplet 19″ focuses the electrons 14 to a small spot at the interaction point 18. The electron beta function, β*, at the interaction point 18 is 1.5 mm in both transverse dimensions compared with maximum beta functions at the triplet of \hat{β}ₓ=73 m and \hat{β}_{y}=190 m for a demagnification factor of a few hundred. FIGS. 21-28 show the time-dependent variation of electron beam parameters at the IP. The electron beam properties are summarized in Table III, below.

TABLE III
Electron beam parameters at the laser interaction point:

| Parameter | Value | Unit |
|---|---|---|
| Peak current | 70 | Amps |
| Normalized emittance | 2 × 10⁻⁷ | m-rad |
| RMS δE/E | 5 × 10⁻⁴ | — |
| Energy | 8-40 | MeV |
| Bunch charge | 100 | pC |
| RMS bunch length | 490 | fs |
| Beta function at IP | 1.5 | mm |
| Beam size at IP | 1.9 | μm |
| Repetition rate | 100 | kHz |
| Average current | 10 | μA |

After colliding with the ICS laser beam 12, the electron beam 14 is bent with a dipole magnet 32 into a lead-lined electron beam dump 34, as shown in FIGS. 1 and 12. The total electron beam power at the dump 34 is 100 W or less, which is easily shielded for radiation protection.

### Laser Technologies:

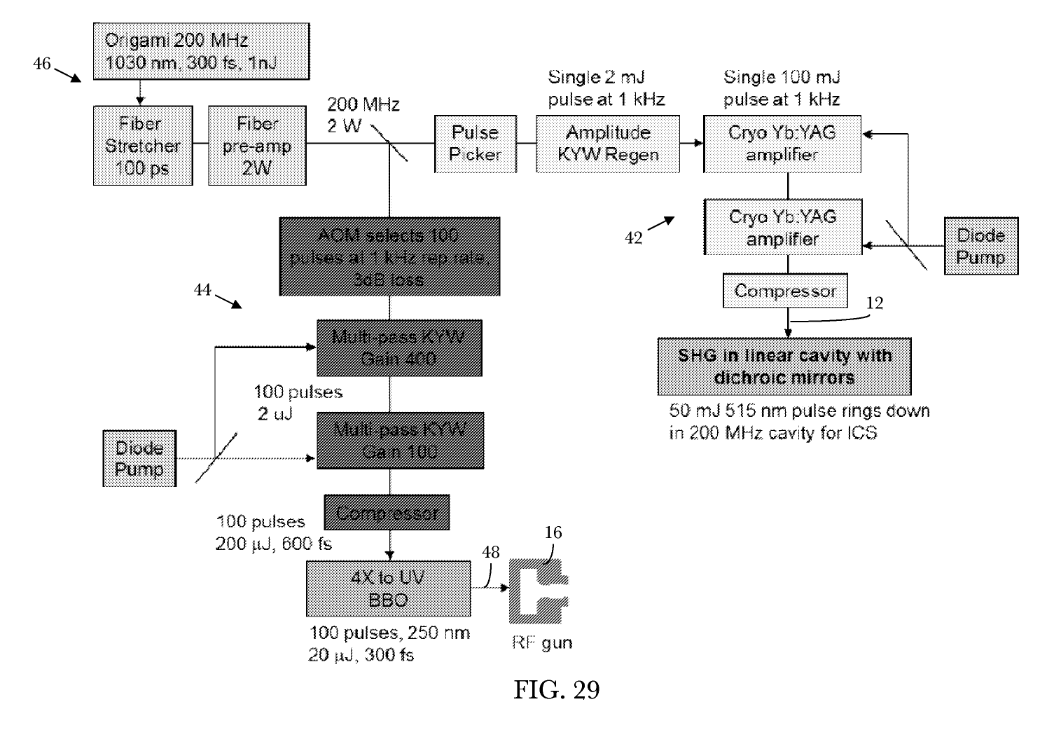

An integral part of the ICS source is the laser system, which provides both the ICS laser 22 and the photocathode laser. A schematic layout of the laser system, shown in FIG. 29, consists of two amplifier chains 42 and 44 driven by the same fiber oscillator 46 to simplify synchronization. The fiber oscillator 46 operates at a repetition rate of 200 MHz, which sets the frequency for the burst of electron pulses 14. The bandwidth of the 1-nJ fiber oscillator pulse is 12 nm to counteract the effects of gain narrowing in the two amplifier chains 42 and 44. The fiber oscillator pulse is stretched to 100 ps and amplified to 10 nJ in order to provide enough pulse energy for the two amplifier chains 42 and 44. The first amplifier chain 42 is used to pump the ICS laser cavity 28. The first amplifier chain 42 selects pulses at 1 kHz and amplifies them to 2 mJ, followed by a cryogenic multi-pass Yb:YAG amplifier to reach 100 mJ with 2.8 ps pulse width. This pulse is coupled into a ringdown cavity 28 by passing it through a dichroic mirror 30 and frequency doubling to produce green light. The conversion to green light simplifies the cavity design and allows it to operate as a ringdown cavity 28 with modest synchronization requirements. The green wavelength (instead of infrared) also permits operating with a lower-energy electron beam 14 that saves on the cost of the accelerator equipment. The laser beam 12 is shown colliding at a small angle offset from head on (in FIG. 1) to allow the electron beam 14 and the x-ray beam 20 to avoid the laser optics. This cavity 28 allows for 100 interactions with a single laser pulse 12 greatly increasing the x-ray flux.

The second amplifier chain 44 is used for the photoinjector gun 16. This laser requires a different pulse format of 100 pulses at 1 kHz. The same laser oscillator that drives the ICS laser begins a separate laser amplifier chain 44 for the UV photocathode drive laser. The format of the UV cathode laser output 48 is a burst of 100 pulses at 253 nm each separated by 5 ns to produce a train of 100 electron bunches 14 of 100 pC charge each in the accelerator. These parameters are chosen to match the 500 ns flattop region of the high power RF pulse. Two multi-pass Yb:KYW amplifiers increase the IR pulse energy to 200 μJ for an average power of 20 W. The output is frequency doubled twice to produce the UV pulse for the photo-injector gun 16.

The burst mode of operation has been previously used in LINACs, but not for the CD-SAXS operation, nor has ICS been applied as a technique for CD-SAXS.

### ICS Collision Laser:

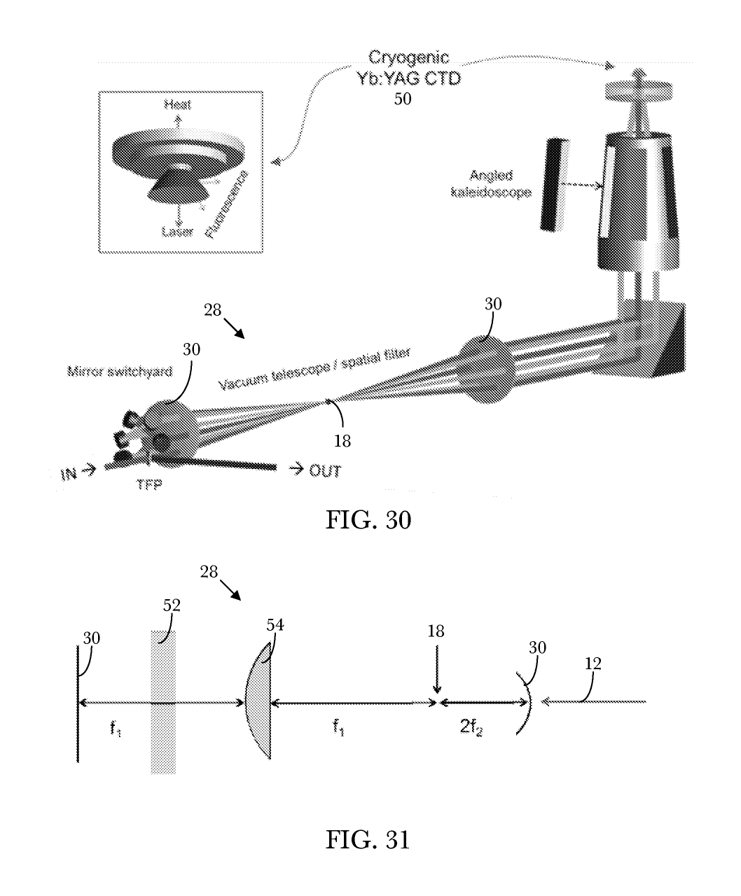

In one embodiment, the ICS collision laser 22 is a high-energy high-power cryogenic composite-thin-disk Yb:YAG with cryogenically cooled Yb:YAG gain elements in a strictly image-relayed multipass architecture to reach our goal of building a 100 W average power laser system delivering 100 mJ pulses of 2.8 ps duration to drive the ICS laser ringdown cavity 28. The heart of this laser driver is a diode pumped cryogenic composite thin disk 50 (insert in FIG. 30) that we estimate can surpass the performance of traditional thin disks. On the cooled face of the disk 50, the laser-grade high-reflector exists in intimate contact through soldering with a cryogenically cooled heat-spreader. The opposite face of the thermally-loaded gain-sheet is diffusion bonded to an index-matched cap of undoped yttrium aluminum garnet (YAG). The function of the undoped cap is to dilute fluorescence, diminishing the influence of amplified spontaneous emission (ASE) and dramatically enhancing energy storage of inverted Yb³⁺ ions. The edges are fashioned to eject fluorescence; furthermore, the much stiffer gain element affords resilience to thermo-mechanical deformations for excellent beam quality.

A chirped pulse amplification technique is utilized, as described in D. Strickland, et al., Optics Commun. 56, 219 (1985). The seed pulses for the amplifier chain 42 are generated from a femtosecond Yb-doped fiber laser 22 and stretched with conventional gold-ruled (Horiba) gratings. The seed is boosted to ˜5 nJ with an in-line Yb-doped fiber amplifier before injecting a commercial Yb:KYW regenerative amplifier that outputs 2 mJ, ˜1 ns pulses at repetition rates up to 1 kHz. To achieve high pulse energy, which needs high gain, we devised a strictly image-relayed multi-pass architecture; and the significant thermo-mechanical, thermo-optical and spectroscopic advantages of operating Yb:YAG at cryogenic temperature were realized. To increase bandwidth, the multi-pass amplifier operates at 130 K, bringing the pulse energy to 100 mJ before being compressed with dielectric-coated gratings.

### Ringdown Cavity:

A linear ringdown cavity 28 was selected because of its ability to produce a small (μm) and symmetric focal spot at the interaction point 18. The linear cavity 28, shown in FIG. 31, is arranged in a 4f geometry for relay imaging. The round trip length of the cavity 28 (between the mirrors 30, wherein the concave mirror at right is a dichroic mirror) is 1.5 meters, which corresponds to the repetition rate of the electron bunches 14 in the burst mode. The cavity loss is on the order of 1% with HR/AR coatings contributing less than 0.2% loss per element and the single-harmonic-generation (SHG) lithium triborate (LBO) crystal 52 contributing 0.2-0.5% loss. This loss will allow for efficient interaction with all 100 of the electron bunches 14 produced in the burst mode. Also shown in the cavity 28 is a fused silica lens 54.

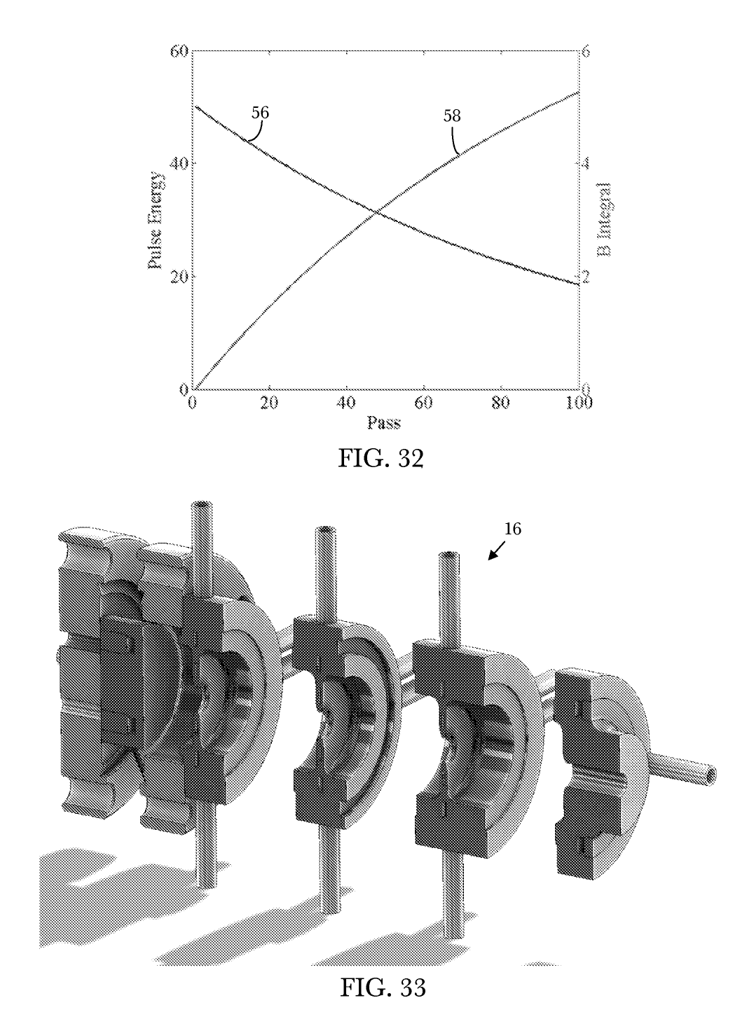

The pulse energy per pass 60 (and B integral 62) is shown in FIG. 32. In order to remain synchronized with the electron bunch burst, the cavity frequency is locked using the fiber oscillator, which seeds the ICS collision laser 22 and the photocathode drive laser. The accumulated temporal offset can be held below 0.5 ps, given the laser pulse and electron bunch width, which corresponds to a cavity stability of 1.5 μm. The 100 mJ infrared (IR) pulse is coupled into the cavity 28 through a dichroic mirror 30. After coupling into the cavity 28, the IR pulse 12 is up-converted to 515 nm via second harmonic generation (SHG) in LBO 52. The target SHG conversion efficiency is 50%, occurring during two passes of the IR pulse 12 through the LBO 52, in order to minimize the losses and undesired non-linearities during the ring down of the cavity 28. The residual IR pulse is removed through the dichroic mirror 30 from which it was coupled into the cavity 28.

Due to the low loss and significant pulse energy, pulse filamentation due to small-scale self-focusing is a significant concern for an optical cavity 28 that contains a lens (SiO₂) 54 and an SHG crystal 52. The susceptibility of the cavity 28 to filamentation is determined by the accumulated B-integral 62, plotted in FIG. 32, which is advantageously kept below two. Due to the large B-integral 62, spatial filtering in the form of an iris at the interaction point 18 is used to remove the higher-order content produced by filamentation. Alternate materials, such as barium borate (BBO) for the SHG crystal 52 and calcium fluoride (CaF) for the lens 54 may serve to further reduce the B-integral 62. Detailed laser cavity parameters are shown in Table IV, below.

TABLE IV
ICS Laser Collision Cavity:

| Parameter | λ = 1030 nm | λ = 515 nm | Unit |
|---|---|---|---|
| Repitition Rate | 200 | | MHz |
| Focal Length (f1) | 34.5 | | cm |
| Focal Length (f2) | 3 | | cm |
| w₀ | 4.1 | 3 | μm |
| wₗₑₙₛ | 26.66 | 18.85 | mm |
| w_{dichroic mirror} | 4.64 | 3.28 | mm |
| Pulse Energy | 100 | 50 | mJ |
| Pulse Width | 2.8 | 2 | ps |
| Peak Surface Intensity | 26.15 | 73.97 | GW/cm² |
| Peak Energy Density | 73.2 | 148 | mJ/cm² |
| Lens Thickness | 2.8 | | mm |
| SHG Crystal Thickness | 1.57 | | mm |
| B-Integral | — | 5.29 | — |
| Passes | 1 | 100 | — |

### Photocathode Drive Laser:

Two significant challenges need to be addressed by the photocathode laser. First, the unique pulse format of 100 electron bunches at 1 kHz and 100 pC requires a significant average power of 20 W. Second, in order for the RF photoinjector 16 to operate in the blowout regime, the UV laser pulse needs to be ˜100 fs.

The design of a photo-cathode laser is based on Yb:KYW multi-pass amplifiers with selection of pulse bursts using an acousto-optic modulator (AOM) pulse picker, as illustrated in FIG. 29. The Yb:KYW gain medium has higher gain cross section than Yb:YAG crystal at room temperature, while having a broad emission bandwidth (e.g., 16 nm) to support sub-ps pulse amplification. The gain medium is suitable for the amplified output power of moderately high average power and low energy per pulse (mJ level) without cryogenic cooling technology. The regenerative amplifier described in the ICS laser section provides a very high gain in a single stage but it cannot amplify the pulse train as needed for a photoinjector 16. Therefore, a multi-stage multi-pass amplifier with a proper gain control is a straightforward way of obtaining a high-power burst of optical pulses 12.

In one design, the gain in the first multi-pass Yb:KYW amplifier is set to 400 to obtain 2 J of energy from individual pulses; and the gain in the second amplifier is set to 100 to obtain 200 J of energy. Each burst 12 contains 100 pulses totaling 20 mJ of energy, reaching 20 W of average power at 1 kHz repetition rate. The control of gain narrowing is important to maintain the final spectral bandwidth broader than 3 nm to compress the pulses to 500 fs. Our calculation shows that the seed spectral bandwidth of 12 nm with the gain of 4×10⁴ will result in the amplified bandwidth of 4.5 nm, which supports a pulse compression to 300 fs. The compressed pulses can be frequency quadrupled into UV pulses in two BBO crystals 52 via cascaded SHG with a conversion efficiency of 10%. Finally, we can obtain a kHz UV burst containing 150 fs pulses with 20 J of energy, which is an advantageous photo-cathode source for an RF gun.

TABLE V
Parameters of RF Structures:

| Parameter | Photoinjector | Linac | Unit |
|---|---|---|---|
| Length | 5.3 | 1013 | cm |
| Number cells | 3.5 | 56 | — |
| Shunt impedance | 105 | 160 | — |
| R/Q | 10 | 10 | Ohm |
| Q | 13,000 | 15,000 | — |
| Energy gain | 3.1 | 31 | MeV |
| RF Power | 3.0 | 2.0 | MW |
| Peak wall E-fld | 150 | 20 | MV/m |
| Peak wall B-fld | 0.5 | 0.5 | T |
| Iris diameter | 6 | 6 | mm |

### RF Photoinjector:

The photoinjector 16 produces the electron beam 14 and provides initial acceleration to relativistic energy. Its critical job is to accelerate a short bunch of electrons 14 from rest at the cathode to a few MeV while maintaining the small beam emittance, low energy spread, and short bunch. To accomplish this, high RF fields of 100 MV/m or more with low aberration and high stability are used. Thermal loading of the copper structure sets the maximum field strength in the high repetition rate regime. X-band structures having 1.5 cells, 2.5 cells, and 3.5 cells have been investigated for their ability to produce an electron beam 14 of several MeV with high cathode gradient, moderate thermal loading, and low RF power demand. The 1.5 cell injector 16 suffers from high thermal load and low exit energy. The 2.5 cell injector can produce a 2 MeV beam with 150 MV/m cathode gradient. The 3.5 cell gun 16 is shown in FIG. 33. The iris shape and cooling channels are designed to limit temperature rise and pulsed heating.

### RF Linac:

The RF LINAC 17 is a standing wave structure at 9300 MHz with wall coupling to every cell. The overall performance of the device allows for an extremely high repetition rate well above 10 kHz for short pulses on the order of 500 ns. With an operational gradient of 10 MV/m, the maximum temperature rise for the iris with a/λ˜0.05 is roughly 10° C. The peak power requirement to achieve this gradient is 740 kW, which leaves plenty of power from the 6 MW klystron to account for beam loading and the gun 16.

### RF Transmitter:

The RF transmitter contains a Scandinova K1 solid state modulator that powers a 9300 MHz klystron from L3 Communications at a repetition rate up to 1 kHz. The nominal RF pulse has a 0.5 μs rise and fall time and 0.5 μs flat top. The L3 tube is rated at 6 MW peak and 20 kW average power.

### CD-SAXS Beamline:

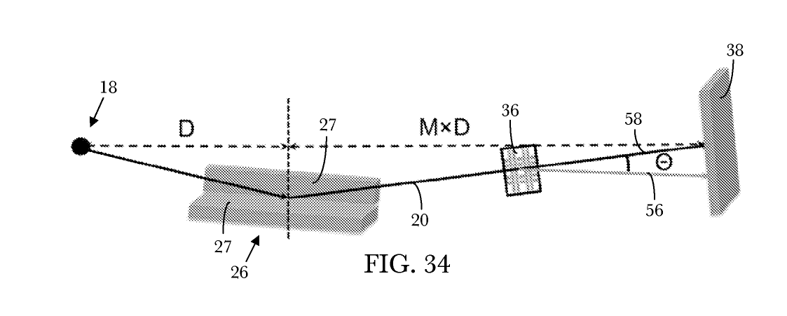

An initial CD-SAXS beamline layout is shown in FIG. 34 using a nested Kirkpatrick-Baez (also known as Montel) optic 26. The diverging x-ray beam 20 is reflected from the mirrors 27 of the optic 26 and then transported to the sample 36. The mirrors 27 are two perpendicular elliptically bent slabs; the x-ray beam 20 is reflected twice, once from each mirror 27. After passing through the sample 36, the scattered x-ray beam 56 is detected by a detector 38, while the unscattered x-ray beam 58 is blocked. The full length of the system is ˜120 cm, depending on the resolution of the detector 38 and size of the sample 36.

The intensity of the x-ray beam 56 scattered by the sample 36 is measured as a function of the momentum transfer, Q, or the scattering angle. At small angles, Q=4π/λ sin(θ/2)≅2πθ/λ. For critical-dimension determination, the sample 36 is a periodic structure with pitch, d, resulting in diffraction orders (Bragg peaks) at momentum transfers, Qd=2πn. The pitch can be obtained from distances between the diffraction orders, δQ=2π/d≅0.3 nm⁻¹ for pitch=22 nm (at 17 keV). Angular positions of the diffraction orders are determined by nλ=2d sin (θ/2)≅dθ. From here, Δθ=λ/d≅3 mrad. In CD-SAXS measurements at the Advanced Photon Source synchrotron facility, about 20 diffraction orders were measured, corresponding to Qₘₐₓ≅20δQ≅6 nm⁻¹ and θₘₐₓ≅60 mrad.

For a source-optic distance of 30 cm, the x-ray beam size at the mirrors 30 is 3 mm assuming beam divergence (FWHM) of 10 mrad. The sample 36 is placed between the optics 26 and the detector 38, where the cross-section of the x-ray beam 20 is the size of the sectional area of the sample 36 (e.g., about 80 μm). For magnification, M=3, the optic-detector distance is 90 cm; thus, samples 36 are placed 2 cm upstream of the detector 38 to be illuminated by the full cross-section of the x-ray beam 20. Using Δθ≅3 mrad, the spatial separation between diffraction orders at the detector 38 will be 60 μm, which can be resolved with a YAG:Ce scintillator and a visible-light CCD camera.

The resolution of such an instrument in which the x-ray beam 20 is focused on the detector 38 is determined by uncertainties of the wavelength and the scattering angle, (ΔQ/Q)²=(Δλ/λ)²+(Δθ/θ)². Assuming ICS bandwidth of 5%, (Δλ/λ)²≅2.5×10⁻³. The geometric contribution is (Δθ)²=(b²+p²)/SDD²+∂_{FE}². Here, SDD is the sample-to-detector distance (2 cm in this example); b is the size of the direct-beam spot on the detector 38; p is the intrinsic resolution of the detector 38; and ∂_{FE}≅5 μrad is the figure error of the mirrors 30. The direct-beam size, b, is determined by the source diameter of 3 μm, and the magnification of the optics 26. Optimally, the magnification of the optics 26 is such that b≅p, which determines the magnification, M. Assuming b≅p≅10 μm, the width of the Bragg peaks, Δθ≅0.7 mrad. Therefore, the geometric contribution to the resolution (Δθ/θ)² decreases quickly with increasing angles, as (Δθ/θ)²=0.05/n², where n is the diffraction order number. Hence, the resolution of the optical system for CD-SAXS is mostly determined by the bandwidth of the source. The full source bandwidth, ΔQ/Q≅Δλ/λ≅5%, will resolve up to the 20th harmonic and can be narrowed if higher resolution is desired to reach even higher harmonics.

A schematic layout of the CD-SAXS optics is illustrated in FIG. 34. Elliptical Kirkpatrick-Baez mirrors 27 focus the x-ray beam 20 at the detector 38, which records the intensity of the scattered photons as a function of the scattering angle, Θ, from the sample 36. The source-to-optic distance (D), the magnification (M), and the optics length are adjusted according to the requirements for the instrument length, the source size and the pixel size of the detector 38. In the example here, D=30 cm, M=3, and the optic is about 20 cm long for a total beamline length of ˜120 cm.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, ⅕^{th}, ⅓^{th}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety; and appropriate components, steps, and characterizations from these references may or may not be included in embodiments of this invention. Still further, the components and steps identified in the Background section are integral to this disclosure and can be used in conjunction with or substituted for components and steps described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A method for characterizing the structure of materials via x-ray scattering, comprising:
generating a burst of electron bunches in a pulse train;
accelerating the electron bunches to relativistic energies;
filling an optical cavity with a laser pulse;
colliding the electron bunches with the laser pulse in the optical cavity, permitting a single laser pulse to interact with the electron bunches to generate x-rays via inverse Compton scattering;
directing the generated x-rays to a sample; and
characterizing the sample by measuring the scattering of the x-rays from the sample.

2. The method of claim 1, wherein the sample is a semiconductor structure, and wherein the x-rays are used to determine critical dimensions of the semiconductor structure by critical-dimension small-angle scattering (CD-SAXS).

3. The method of claim 1, wherein the electron burst includes about 100 bunches at 1 kHz, wherein each bunch has a charge of about 100 pC.

4. The method of claim 1, wherein the pulse train is about 0.5 microseconds long.

5. The method of claim 1, further comprising tuning the electron energy to match an inverse Compton laser scattering resonance condition for a desired x-ray photon energy.

6. The method of claim 5, wherein the x-rays have a photon energy of 1 keV to 100 keV photon.

7. The method of claim 5, wherein the x-rays have a photon energy of about 17 keV.

8. The method of claim 1, wherein the x-rays are used to measure features of the sample with dimensions less than 100 nm.

9. The method of claim 1, wherein the electron bunches are generated in a photocathode.

10. The method of claim 9, wherein the photocathode is operated in a blowout regime.

11. The method of claim 10, further comprising directing an approximately 100 fs photon pulse onto the photocathode to produce the blowout regime.

12. The method of claim 9, wherein the photocathode is driven by a laser oscillator that also generates the laser pulse that fills the optical cavity.

13. The method of claim 12, wherein the laser oscillator generates a first set of pulses that are directed through a first amplifier chain and a second set of pulses that are directed through a second amplifier chain, wherein the first set of pulses, which pass through the first amplifier chain, are directed into the optical cavity, and wherein the second set of pulses, which pass through the second amplifier chain, are directed onto the photocathode.

14. The method of claim 13, wherein the first set of pulses from the first amplifier chain are infrared pulses at about 1 kHz, and wherein the second set of pulses from the second amplifier chain are ultraviolet pulses at about 1 kHz.

15. The method of claim 14, further comprising converting the infrared pulses to green via second harmonic generation.

16. The method of claim 15, wherein the first set of pulses are directed from the first amplifier chain into the linear cavity through a dichroic mirror.

17. The method of claim 16, wherein the first set of pulses convert from infrared to green over two passes through a second-harmonic-generation crystal.

18. The method of claim 1, wherein the optical cavity is filled with a green pulse.

19. The method of claim 1, wherein the optical cavity is a linear cavity.

20. The method of claim 1, wherein the electron bunches are accelerated using a radiofrequency linear accelerator operating in a standing wave mode.

21. The method of claim 1, wherein each electron bunch has a length of about 1 ps.

22. The method of claim 1, further comprising focusing the electron bunches into a small spot with dimensions no greater than about 3 microns at an interaction point for inverse Compton scattering in the optical cavity.

23. The method of claim 1, wherein the electron bunches are redirected with a magnet after exiting the optical cavity.

24. A radiation source, comprising:
a laser system including an oscillator, a first amplifier chain positioned to receive photons from the oscillator, and a second amplifier chain positioned to receive photons from the oscillator;
a laser cavity positioned to receive photons from the first amplifier chain;
an electron source for generating a train of electron bunches, wherein the electron source includes a photocathode configured to receive photons from the second amplifier chain and to release electron bunches when struck by the photons from the second amplifier chain;
a radiofrequency linear accelerator positioned to accelerate the electron bunches generated by the electron source and to direct the accelerated electron bunches into the laser cavity;
an integrated x-ray optic positioned to collect x-rays produced in the laser cavity via inverse Compton scattering due to interaction of the electron bunches and photons in the laser cavity; and
an x-ray detector positioned to record x-rays focused by the x-ray optic on the detector and scattered from the sample.

25. The radiation source of claim 24, wherein the first amplifier chain is configured to produce a pulse at 1 KHz infrared for the laser cavity, and wherein the second amplifier chain is configured to produce about 100 pulses at 1 kHz ultraviolet for the photocathode.

26. The radiation source of claim 24, wherein the electron source is a radiofrequency photo injector.

27. The radiation source of claim 24, wherein the electron source has an electron emission surface with gradients higher than 100 MV/m for producing low emittance electron bunches.

28. The radiation source of claim 24, wherein the laser cavity is oriented at an angle to the train of electron bunches.

29. The radiation source of claim 24, wherein the x-ray optic is placed to refocus magnify or collimate the produced x-rays.
